(19) United States
(12) Patent Application Publication
(10) Pub. No.: US 2011/0067357 A1
(43) Pub. Date: Mar. 24, 2011

(54) Machine for wrapping individual round crop bales with plastic film

(76) Inventor: Glenn Martin Wenger, Richfield, PA (US)

(21) Appl. No.: 12/586,497

(22) Filed: Sep. 23, 2009

(51) Int. Cl. B65B 11/56; A01F 15/00

(52) U.S. Cl. 53/216

(57) ABSTRACT

A machine for wrapping individual round crop bales with plastic film as they are rolled along the ground is disclosed having a frame, with an arm situated over the center of the bale, a rotating arm, attached to the end of the frame arm, a holder for the film roll attached to the rotating arm, allowing the roll to turn as the film feeds out, a roller mounted to the frame to push and roll the bale on the ground on its horizontal axis, as it is wrapped by the rotating arm, rotating on a vertical axis, resulting in a completely wrapped bale. In the preferred embodiment, the machine is mounted on the three point hitch of a tractor, with the rotating arm powered by the tractor hydraulics, and an optional “ground” roller mounted to the frame to support the wrapper close to the ground while wrapping.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of agricultural devices and more specifically to a machine for wrapping individual round bales with plastic film while they are rolled on the ground.

The storage of grass as hay for animal feed has a history going back thousands of years. Typically grass or other crops have been cut and dried in the sun, then raked into windrows and baled into convenient size bales for storage. The round baler has been a popular choice for many years, producing a bale typically about 4′ diameter by about 4′ wide.

A major problem with baling hay has always been getting it dry enough to avoid spoiling in storage. This problem was addressed by baling the crop at higher moisture levels, and wrapping the bales in plastic film to seal out the oxygen. In this case, the crop goes through a beneficial “ensiling” fermentation process that produces an excellent livestock feed, often called “baleage”.

Two types of machines are in common use for the bale wrapping process. One type wraps bales together placed end to end in one long windrow. The advantage of these machines is that they use less plastic film, since they don't need to wrap the ends of each bale. The disadvantage is that when the plastic is opened and a bale taken out, the next bales get exposed to air and can start spoiling. The rest must be fed fairly rapidly. The second type wraps each bale individually and completely, sealing our air until the bale is ready to be fed. The present invention is of this type.

Machines currently on the market do a good job of wrapping bales. However, they are heavy, complicated and expensive machines that are only affordable to large operations, or custom operators. They are necessarily so heavy, expensive and complex because they need to load the bale onto the wrapper itself, and slowly turn the bale in one axis, while spinning it on the other axis, or slowly turn the bale in one axis while a rotating arm circles it with the plastic film. The fact that the bale is loaded on the machine adds complexity and expense.

### BRIEF SUMMARY OF THE INVENTION

The primary object of the invention is to provide a more economical solution to completely and individually film wrap crop bales.

Another object of the invention is to provide a simple, easy to operate and maintain bale wrapper, practical for small farmers.

A further object of the invention is to provide a trouble free, reliable machine through a simple design.

Still yet another object of the invention is to provide a bale wrapper in which the bale does not need to be loaded onto the machine to wrap it.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a simple machine for wrapping individual round crop bales with plastic film as they are rolled along the ground comprising: a frame, mounted to the three point hitch of a tractor with an arm situated over the center of the bale, a rotating arm, attached to the end of the frame arm powered by a hydraulic motor, a hydraulic speed regulating valve, a holder for the film roll and film stretching rolls attached to the rotating arm, through which the film feeds, a roller mounted to the frame to roll the bale as it is wrapped, and an optional “ground” roller mounted to the frame to support the wrapper close to the ground.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a top view of the invention.

FIG. 2 is a side view of the invention.

FIG. 3 is a perspective view of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

Round bale wrapping machines of other designs are currently available. However, this invention is unique in its simplicity, and in that rather than loading the bale on to the machine to rotate it, the machine simply rolls the bale along the ground, wrapping it while it is rolling. While the bale is rolling, turning on its horizontal axis, being pushed by a roller on the machine, a rotating arm on the machine, rotating on a vertical axis wraps plastic film around the bale. The combination of rolling in one axis while it is being wrapped by an arm rotating in another axis completely wraps the bale on all sides and circumference. The actual process may be done in various ways without departing from my invention, however I give an example below.

In the preferred embodiment, the machine is coupled to the three point hitch of a tractor, and by the tractor backed up against the bale. The operator or an assistant pulls out the end of the film and tucks it under a bale string. Alternately, the end of the plastic is held on the machine by an optional plastic cutting and holding mechanism. The tractor operator then activates the hydraulic motor, rotating the rotating arm around the bale, wrapping the plastic. After two or three wraps, the operator slowly backs up the tractor, which causes the machine's roller to roll the bale, while the rotating arm continues to wrap film around the bale. After about one half turn of the bale, it is completely wrapped, and the operator or assistant cuts the film, or alternately activates an optional film cutting and holding mechanism. The tractor and machine is then driven away to the next bale.

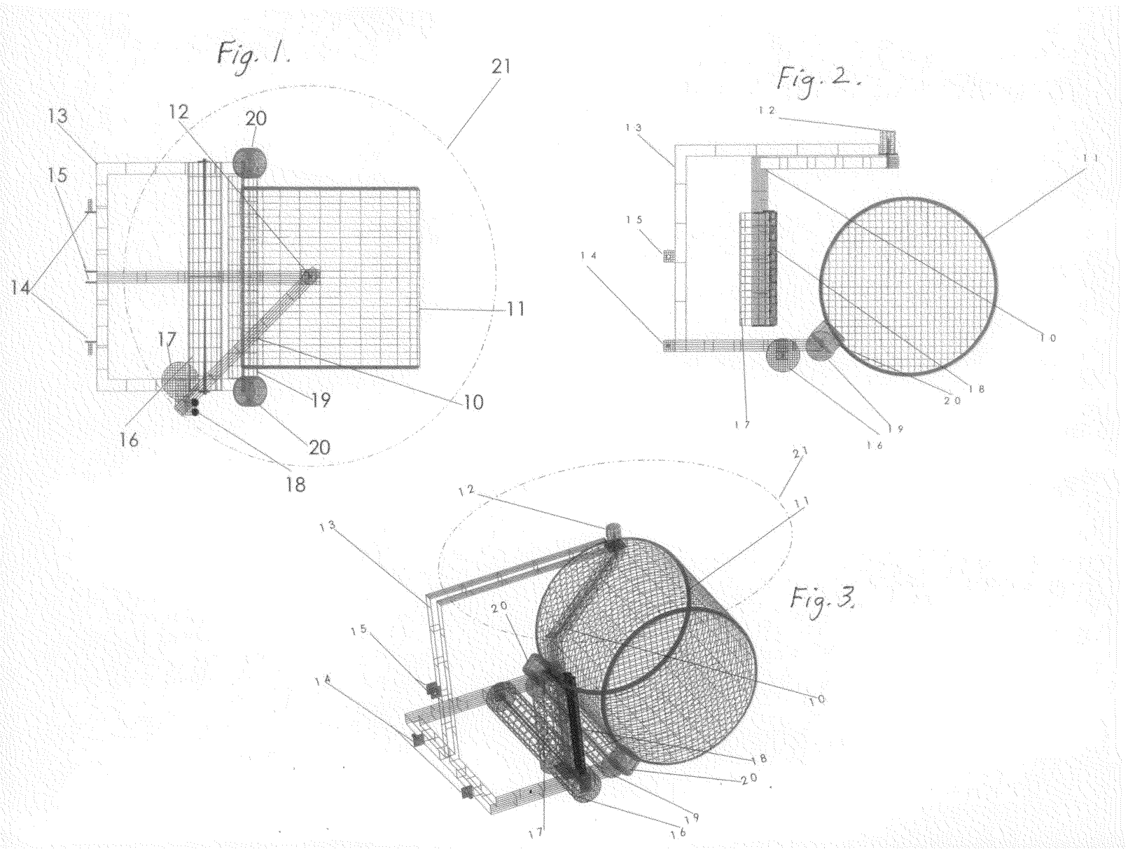

Turning now to the drawings, each figure is a different view of the same drawing and uses the same part numbers. FIG. 1 is a top view. FIG. 2 is a side view, and FIG. 3 is a perspective view. Each view shows the invention in working position with a round hay bale. The invention comprises a rigid frame 13, whereon is affixed on one end, three point hitch links 14 & 15 for mounting to a tractor, and at the other end, close to the bottom, a bale roller 19, for pushing and rolling the bales, bale guide rolls 20 on each side to keep the bale in place, and below an optional ground roller 16 to keep the machine at the proper height. An upper projection of the frame stands out over the bottom rollers, to the center of the bale being wrapped, where is mounted a hydraulic motor 12, powered by the tractor's hydraulic system, and powering a rotating arm 10, which circles the bale 11. The rotating arm carries the plastic film roll 17, and prestretching rollers 18 in an orbit 21, around the bale, wrapping the plastic film onto the bale.

Minor details not essential to the concept being patent are not all included in the drawings and descriptions. This would include, but not limited to: a hydraulic speed control valve in the line of the hydraulic motor, to limit rotating arm speed; a optional film cutting and holding device, to enable one operator to wrap bales, starting and finishing quickly without leaving the tractor seat.

Variations of the above could be made, including: Rather than being coupled to a tractor, the machine could be self propelled, with its own hydraulic system. Alternately, the rotating arm could be powered by electric motor, or any mechanical means. A plastic film cutting and holding mechanism could be mounted to the frame, to cut the film, enabling the tractor to drive to the next bale, and continuing to hold the end of the film until the wrapping has started on the bale.

The major advantages of this machine over prior art are the simplicity and economy gained by simply rolling the bale on the ground to wrap it instead of loading it on to a much more complex machine that would do the turning and wrapping.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A machine for wrapping individual round crop bales with plastic film comprising:
a frame, with rollers or other pushing mechanism, strong enough to roll a heavy crop bale on its horizontal axis, and a rotating arm to wrap the bale in plastic film while it is being rolled on the ground;
a means of attaching the frame to a tractor;
a rotating arm, attached to the end of the frame arm;
a hydraulic motor or other means of rotating the rotating arm;
a holder for the film roll attached to the rotating arm, allowing the roll to turn as the film feeds out;
a film stretching roll assembly attached to the rotating arm, through which the film feeds;
a roller mounted to the frame to roll the bale as it is wrapped; and
an optional “ground” roller mounted to the frame to support the wrapper close to the ground.
